(19) United States
(12) Patent Application Publication
(10) Pub. No.: US 2011/0315030 A1
(43) Pub. Date: Dec. 29, 2011

(54) PHOTOGRAVURE PROCESS FOR IDENTIFICATION CODE

(76) Inventor: CHUN-HUANG LIN, Taipei City (TW)

(21) Appl. No.: 12/825,362

(22) Filed: Jun. 29, 2010

(51) Int. Cl. B41M 1/10

(52) U.S. Cl. 101/170

(57) ABSTRACT

A photogravure process for an identification code includes Step A. making a press plate by using a seamless steel tube or a copper tube as a press plate substrate, and engraving an information of the identification code onto the press plate substrate by means of electric engraving or laser engraving; and Step B. printing the information of the identification code by using a monochrome gravure printing press or a multi-color gravure printing press to print the information of the identification code on a film substrate, so as to form the ink information layer. By using the photogravure process, the identification code printed has the benefits of solid and rich colors, clear graphics and letters, appropriate contrast, and realistic images. In addition, the disclosed photogravure process allows high printing efficiency with a printing speed up to 100 m/min while the cost required is low.

### BACKGROUND OF THE INVENTION

1. Technical Field

The present invention relates to printing technologies for identification codes, and more particularly to a photogravure process for an identification code.

2. Description of Related Art

At present, printing of identification codes is mainly relied on relief printing, which involves evenly distributing ink in the ink feed system of a printing press and then transferring the ink to the press plate through an ink roller, wherein since on the relief printing plate, the patterned part is much larger than un-patterned part, the ink on the ink roller can be only transferred to the patterned part of the press plate while the un-patterned part is left un-inked. The paper feed system of the printing press then delivers paper to the printing components of the printing press, so that with the cooperation of the press plate system and the impression system, the ink on the patterned part of the press plate is transferred to an object to be printed, thereby accomplishing the printing process and producing prints. Relief printing is subject to its printing velocity and excessive velocity can degrade clarity of the printed graphic or letters. Moreover, a relief printing plate typically produce thick prints which can bring about problems of set-off, mottles, moire patterns, glossless prints as well as poor color overlap. The patterned part is raised from the relief printing plate and tends to break under impact and the damaged plate has to be remade, suggesting a relatively high overall printing cost.

### SUMMARY OF THE INVENTION

The objective of the present invention is to overcome the shortcomings of the prior art by providing a photogravure process for an identification code, wherein the process is more efficient and less costly as compared with the prior art.

To achieve the above objective, the photogravure process of the present invention comprises:

Step A: making a press plate by using a seamless steel tube or a copper tube as a press plate substrate, and engraving an information of the identification code onto the press plate substrate by means of electric engraving or laser engraving; and

Step B: printing the information of the identification code by using a monochrome gravure printing press or a multi-color gravure printing press to print the information of the identification code on a film substrate, so as to form the ink information layer.

Therein, a wear-proof layer is coated on an unprinted surface of the ink information layer so as to form the identification code.

Therein, a release layer is arranged between the ink information layer and the wear-proof layer.

Therein, an adhesive layer is laminated beneath the wear-proof layer.

Therein, the unprinted surface of the ink information layer is placed upward, and a foam layer or a non-foam layer is adhered to a printed surface of the ink information layer.

Therein, the foam layer is a layer of PVC foam, PE foam or POE foam, and the non-foam layer is a layer of unfoamed PVC, unfoamed PE or unfoamed POE.

Therein, the film substrate is a piece of plastic film made of BOPP, PET, PVC or PE and the film has a thickness of 5˜20 μm.

Therein, the release layer is a layer of cellulose acetate and has a thickness of 0.2˜3 μm.

Therein, the wear-proof layer is a layer of PU resin and has a thickness of 0.2˜3 μm.

Therein the adhesive layer is a layer of hot-melt adhesive and has a thickness of 0.2˜3 μm.

The present invention comprises Step A: making a press plate by using a seamless steel tube or a copper tube as a press plate substrate, and engraving an information of the identification code onto the press plate substrate by means of electric engraving or laser engraving; and Step B: printing the information of the identification code by using a monochrome gravure printing press or a multi-color gravure printing press to print the information of the identification code on a film substrate, so as to form the ink information layer. Therefore the identification code printed through the photogravure process has the benefits of solid and rich colors, clear graphics and letters, appropriate contrast, and realistic images. In addition, the disclosed photogravure process allows high printing efficiency with a printing speed up to 100 m/min while the cost required is low.

### DETAILED DESCRIPTION OF THE INVENTION

The embodiments given below are intended to facilitate the understanding of people skilled in the art to the present invention, without limiting the implement of the present invention in any respect.

### Embodiment 1

A photogravure process for an identification code comprises the following steps:

Step A: making a press plate by using a seamless steel tube as a press plate substrate, and engraving an information of the identification code onto the press plate substrate by means of laser engraving; and

Step B: printing the information of the identification code by using a monochrome gravure printing press to print the information of the identification code on a plastic film made of PET. As adopted herein, the ink is carbonic ink and the film has a thickness of 5 μm, forming the ink information layer. In the course of printing, the ink is added to the press plate substrate so that the ink falls into the recessed pattern of the information of the identification code naturally. Then the surplus ink on the surface of the press plate is wiped up without removing the ink in the recessed pattern of the information of the identification code. Afterward, the plastic film made of PET is placed thereon and a relative large pressing force is applied to impress the ink in the shape of the information of the identification code onto the PET film, thereby forming the ink information layer. A layer of PU resin is coated on the unprinted surface of the ink information layer for acting as a wear-proof layer, whose thickness is of 0.2 μm. A layer of cellulose acetate is arranged between the ink information layer and the wear-proof layer for acting as a release layer, whose thickness is of 0.2 μm. A layer of hot-melt adhesive is laminated beneath the wear-proof layer for acting as an adhesive layer, whose thickness is of 0.2 μm. The identification code is thereby formed.

### Embodiment 2

A photogravure process for an identification code comprises the following steps:

Step A: making a press plate by using a copper tube as a press plate substrate, and engraving an information of the identification code onto the press plate substrate by means of electric engraving; and

Step B: printing the information of the identification code by using a multi-color gravure printing press to print the information of the identification code on a plastic film made of BOPP. As adopted herein, the ink is carbonic ink and the film has a thickness of 20 μm, forming the ink information layer. In the course of printing, the ink is added to the press plate substrate so that the ink falls into the recessed pattern of the information of the identification code naturally. Then the surplus ink on the surface of the press plate is wiped up without removing the ink in the recessed pattern of the information of the identification code. Afterward, the plastic film made of BOPP is placed thereon and a relative large pressing force is applied to impress the ink in the shape of the information of the identification code onto the BOPP film, thereby forming the ink information layer. A layer of PU resin is coated on the unprinted surface of the ink information layer for acting as a wear-proof layer, whose thickness is of 3 μm. A layer of hot-melt adhesive is laminated beneath the wear-proof layer for acting as an adhesive layer, whose thickness is of 3 μm. The identification code is thereby formed.

### Embodiment 3

A photogravure process for an identification code comprises the following steps:

Step A: making a press plate by using a copper tube as a press plate substrate, and engraving an information of the identification code onto the press plate substrate by means of electric engraving; and

Step B: printing the information of the identification code by using a monochrome gravure printing press to print the information of the identification code on a plastic film made of PVC. As adopted herein, the ink is carbonic ink and the film has a thickness of 10 μm, forming the ink information layer. In the course of printing, the ink is added to the press plate substrate so that the ink falls into the recessed pattern of the information of the identification code naturally. Then the surplus ink on the surface of the press plate is wiped up without removing the ink in the recessed pattern of the information of the identification code. Afterward, the plastic film made of PVC is placed thereon and a relative large pressing force is applied to impress the ink in the shape of the information of the identification code onto the PVC film, thereby forming the ink information layer. A layer of PU resin is coated on the unprinted surface of the ink information layer for acting as a wear-proof layer, whose thickness is of 2 μm. A layer of cellulose acetate is arranged between the ink information layer and the wear-proof layer for acting as a release layer, whose thickness is of 2 μm. The identification code is thereby formed.

### Embodiment 4

A photogravure process for an identification code comprises the following steps:

Step A: making a press plate by using a seamless steel tube as a press plate substrate, and engraving an information of the identification code onto the press plate substrate by means of laser engraving; and

Step B: printing the information of the identification code by using a monochrome gravure printing press to print the information of the identification code on a plastic film made of PET. As adopted herein, the ink is carbonic ink and the film has a thickness of 5 μm, forming the ink information layer. In the course of printing, the ink is added to the press plate substrate so that the ink falls into the recessed pattern of the information of the identification code naturally. Then the surplus ink on the surface of the press plate is wiped up without removing the ink in the recessed pattern of the information of the identification code. Afterward, the plastic film made of PET is placed thereon and a relative large pressing force is applied to impress the ink in the shape of the information of the identification code onto the PET film, thereby forming the ink information layer. The unprinted surface of the ink information layer is placed upward, and PVC foam layer is adhered to a printed surface of the ink information layer.

### Embodiment 5

Embodiment 5 of the present invention adopts the same process as described in Embodiment 1 except for the thickness of the film being 15 μm, the thickness of the release layer thickness being 1.5 μm; the thickness of the wear-proof layer thickness being 1.5 μm, and the thickness of the adhesive layer being 1.5 μm.

### Embodiment 6

Embodiment 6 of the present invention adopts the same process as described in Embodiment 2 except for the thickness of the film being 5 μm, the thickness of the wear-proof layer being 0.8 μm, and the thickness of the adhesive layer being 1 μm.

### Embodiment 7

Embodiment 7 of the present invention adopts the same process as described in Embodiment 3, except for the thickness of the film being 5 μm, the thickness of the release layer being 0.8 μm, the thickness of the wear-proof layer being 0.8 μm, and the thickness of the adhesive layer being 1 μm.

### Embodiment 8

Embodiment 8 of the present invention adopts the same process as described in Embodiment 1, except for the thickness of the film being 5 μm, the thickness of the release layer being 0.8 μm, the thickness of the wear-proof layer being 0.8 μm, and the thickness of the adhesive layer being 1 μm.

### Embodiment 9

Embodiment 9 of the present invention adopts the same process as described in Embodiment 2, except for the thickness of the film being 12 μm, the thickness of the wear-proof layer being 2.1 μm, and the film and the wear-proof layer being directly laminated without using the adhesive layer.

### Embodiment 10

Embodiment 10 of the present invention adopts the same process as described in Embodiment 1, except for the film being made of PE with a thickness of 8 μm, the thickness of the release layer being 1 μm, the thickness of the wear-proof layer being 1 μm, and the thickness of the adhesive layer being 1 μm.

### Embodiment 11

Embodiment 11 of the present invention adopts the same process as described in Embodiment 4, except for the unprinted surface of the ink information layer being placed upward, and a layer of unfoamed PVC being adhered to the printed surface.

### Embodiment 12

Embodiment 12 of the present invention adopts the same process as described in Embodiment 4, except for the unprinted surface of the ink information layer being placed upward, and a layer of unfoamed PE being adhered to the printed surface.

### Embodiment 13

Embodiment 13 of the present invention adopts the same process as described in Embodiment 4, except for the unprinted surface of the ink information layer being placed upward, and a PE foam layer being adhered to the printed surface.

### Embodiment 14

Embodiment 14 of the present invention adopts the same process as described in Embodiment 4, except for the unprinted surface of the ink information layer being placed upward, and a layer of unfoamed POE being adhered to the printed surface.

### Embodiment 15

Embodiment 15 of the present invention adopts the same process as described in Embodiment 4, except for the unprinted surface of the ink information layer being placed upward, and a POE foam layer being adhered to the printed surface.

Additionally, the present invention may include laminating foam and/or non-foam layers made of various materials as long as it is needed.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A photogravure process for an identification code, the process comprising:
Step A: making a press plate by using a seamless steel tube or a copper tube as a press plate substrate, and engraving an information of the identification code onto the press plate substrate by means of electric engraving or laser engraving; and
Step B: printing the information of the identification code by using a monochrome gravure printing press or a multi-color gravure printing press to print the information of the identification code on a film substrate, so as to form the ink information layer.

2. The photogravure process of claim 1, wherein a wear-proof layer is coated on an unprinted surface of the ink information layer so as to form the identification code, wherein an adhesive layer is laminated beneath the wear-proof layer.

3. The photogravure process of claim 2, wherein a release layer is arranged between the ink information layer and the wear-proof layer, wherein an adhesive layer is laminated beneath the wear-proof layer.

4. The photogravure process of claim 1, wherein the unprinted surface of the ink information layer is placed upward, and a foam layer or a non-foam layer is adhered to a printed surface of the ink information layer.

5. The photogravure process of claim 4, wherein the foam layer is a layer of PVC foam, PE foam or POE foam, and the non-foam layer is a layer of unfoamed PVC, unfoamed PE or unfoamed POE.

6. The photogravure process of claim 1, wherein the film substrate is a piece of plastic film made of BOPP, PET, PVC or PE and the film has a thickness of 5˜20 μm.

7. The photogravure process of claim 3, wherein the release layer is a layer of cellulose acetate and has a thickness of 0.2˜3 μm.

8. The photogravure process of claim 2, wherein the wear-proof layer is a layer of PU resin and has a thickness of 0.2˜3 μm.

9. The photogravure process of claim 1, wherein the adhesive layer is a layer of hot-melt adhesive and has a thickness of 0.2˜3 μm.
